(19) United States
(12) Patent Application Publication
(10) Pub. No.: US 2018/0087717 A1
(43) Pub. Date: Mar. 29, 2018

(54) VALVE FOR PRESSURIZED FLUID

(71) Applicant: L'Air Liquide, Société Anonyme pour l'Etude et I'Exploitation des Procédés Georges Claude, Paris (FR)

(72) Inventors: Benjamin Fischer, L'Hay-les-Roses (FR); Antoine Frenal, Evanville (FR)

(21) Appl. No.: 15/711,223

(22) Filed: Sep. 21, 2017

(30) Foreign Application Priority Data
Sep. 26, 2016 (FR) 1659022

(51) Int. Cl. F17C 13/04; F17C 1/00; F17C 13/02

(52) U.S. Cl. CPC F17C 13/04; F17C 1/00; F17C 13/025; F17C 13/026; F17C 2250/0439; F17C 2205/0338; F17C 2205/0394; F17C 2250/043; F17C 2205/0329

(57) ABSTRACT

Valve for pressurized fluid, with or without an incorporated pressure relief device, including a body housing a fluid circuit having an upstream end intended to be connected to a pressurized fluid reserve and a downstream end intended to be connected to a receiving apparatus, the fluid circuit including a member for controlling the flow rate in the fluid circuit, the member for controlling the flow rate being commanded by an actuating member mobile with respect to the body of the valve, the valve including at least one electronic functional member arranged in a closed casing located on the body, wherein the casing includes a peripheral wall in communication with the exterior of the valve, the peripheral wall including at least

### CROSS REFERENCE TO RELATED APPLICATIONS

This application claims the benefit of priority under 35 U.S.C. § 119 (a) and (b) to French Patent Application No. 1659022, filed Sep. 26, 2016, the entire contents of which are incorporated herein by reference.

### BACKGROUND

The invention relates to a valve for pressurized fluid and a pressurized fluid bottle or set of bottles comprising such a valve.

### SUMMARY

The invention relates more particularly to a valve for pressurized fluid, with or without an incorporated pressure relief device, comprising a body housing a fluid circuit having an upstream end intended to be connected to a pressurized fluid reserve and a downstream end intended to be connected to a receiving apparatus, the fluid circuit comprising a member for controlling the flow rate in the fluid circuit, the member for controlling the flow rate being commanded by an actuating member mobile with respect to the body of the valve, the valve comprising at least one electronic functional member arranged in a closed casing located on the body.

In order to improve the functionalities of a valve for a pressurized fluid bottle or bottles, it is known to provide electronic members for measuring and/or for communicating wirelessly.

Reference should be made, for example, to the document FR2868160A1 which describes a modular system incorporating an electronic sensor for measuring the autonomy of a pressurized gas reservoir.

These electronic members are generally housed in closed plastic casings. Although these valves are provided with safety flaps intended to evacuate possible leaks or excess pressure, the casing(s) containing the electronic members can capture possible gas leaks. In some situations, this can produce increases in pressure in these casings which can cause bursting.

An aim of the present invention is to overcome all or some of the disadvantages of the prior art which have been set out above.

To this end, the valve according to the invention, moreover in accordance with the generic definition thereof given in the preamble above, is mainly characterized in that the casing comprises a peripheral wall in communication with the exterior of the valve, said peripheral wall comprising at least one vent hole shut by a cover fixed on said peripheral wall.

Moreover, embodiments of the invention can include one or more of the following features:
the cover comprises or is formed from an impervious plastic material layer stuck on said peripheral wall,
the plastic material layer is flexible,
the plastic material layer comprises at least one of the following: rubber, a polymer,
the cover is locally thinned or partially pre-cut at or adjacent to the vent hole,
the valve includes several vent holes,
the peripheral wall comprising the at least one vent hole forms an upper wall of the casing and of the valve when the valve is configured for use,
the casing is removably mounted on the body of the valve,
the casing houses at least part of the casing fluid circuit,
the control member comprises at least one of the following: an isolation flap, a flow rate or pressure regulation gate, a mobile flap-pusher member for actuating a flap of another apparatus to which the valve is intended to be connected,
the at least one electronic functional member comprises at least one of the following: a device for receiving and/or transmitting data wirelessly comprising an antenna, a pressure and/or temperature sensor, an electronic logic for storing and processing data comprising a microprocessor, a digital screen, and a light source.

The invention also relates to a pressurised fluid bottle or set of bottles comprising a valve according to any one of the features above or below.

The invention can also relate to any alternative device or method comprising any combination of the features above or below.

### BRIEF DESCRIPTION OF THE DRAWINGS

Other characteristic features and advantages will emerge upon reading the following description, with reference to the figures wherein:

FIG. 1 shows a partial and schematic sectional view illustrating a first valve structure mounted on a reservoir, in accordance with one embodiment of the present invention,

FIG. 2 shows a partial and schematic sectional view illustrating another valve structure, in accordance with one embodiment of the present invention,

FIG. 3 shows a partial and schematic exploded perspective view of a detail of a valve illustrating the structure of a vent system of an upper peripheral wall, in accordance with one embodiment of the present invention,

FIG. 4 shows a partial and schematic enlarged sectional view of a detail of the upper peripheral wall of a casing of a valve, in accordance with one embodiment of the present invention.

### DESCRIPTION OF PREFERRED EMBODIMENTS

The valve 1 shown in the figures comprises a body 2 conventionally housing a fluid circuit 3 having an upstream end 4 intended to be connected to a pressurized fluid reserve (a bottle 13 or a set of bottles for example) and a downstream end 5 intended to be connected to an apparatus using the gas provided by the pressurized fluid reserve.

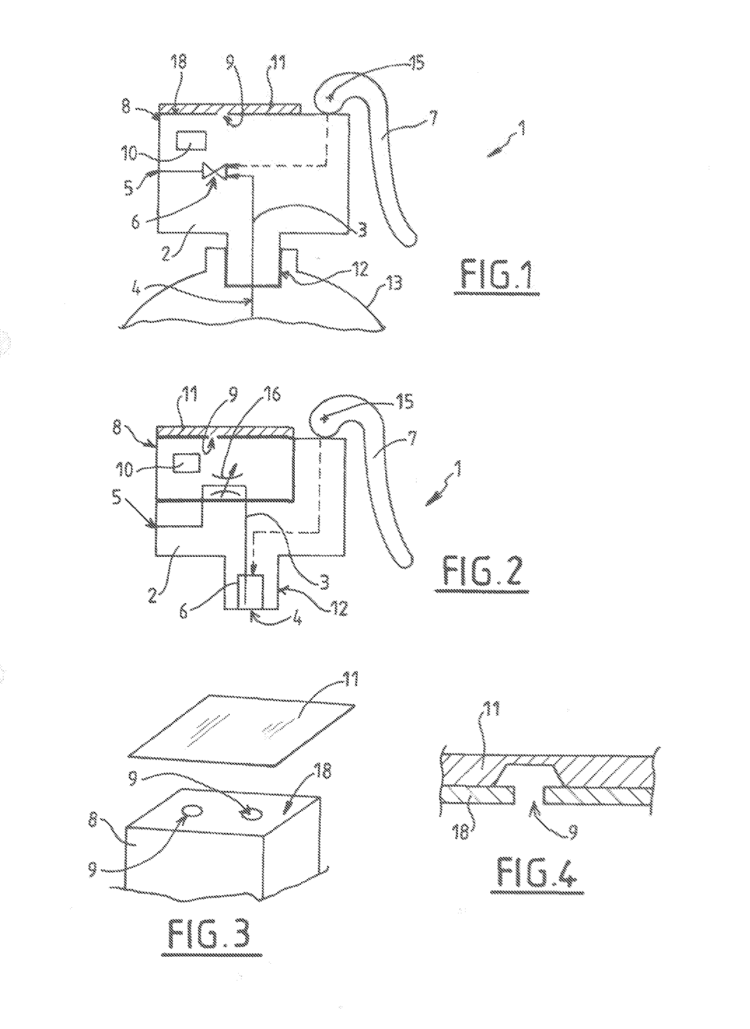

As illustrated in FIG. 1, the circuit 3 can conventionally comprise a gate 6 for controlling the flow rate in the circuit 3. This gate 6 can be an isolation flap for opening and closing the circuit 3 and/or a flap for setting a flow rate or a pressure or any other type of appropriate flap.

The gate 6 is commanded by a lever 7 pivotably mounted on the body 2 of the valve 1 (at, for example, one hinge 15 at least).

The lever 7 is mobile between a rest position (FIG. 1) in which the gate 6 is kept in a first state corresponding to a first value for flow rate in the circuit 3 (for example a zero flow rate) and an active second position (lever lifted for example) in which the lever 7 moves the gate 6 into a second state corresponding to a second value for flow rate in the circuit 3 (for example circuit completely open for a maximum flow rate).

As shown in the diagram of FIG. 1, the valve 1 can be connected (fixed, for example, by screwing via catching members 12) to a pressurized fluid bottle 13.

The member 6 for controlling flow rate in the circuit 3 shown in FIG. 1 comprises a gate 6, but any other member 6 for controlling flow rate could be envisaged.

For example, alternatively or in combination, and as illustrated in FIG. 2, the valve 1 could comprise a mobile piece such as a flap-pusher, the movement of which is commanded by the lever 7. This flap-pusher 6, which is translatable for example, can be provided, for example, to actuate (in particular open) a system of a flap or flaps which is located on another valve or a bottle on which the valve 1 is connected in order to draw or transfer pressurized fluid.

For example, this valve 1 could be connectable (via the catching members 12), in a removable manner, to another separate valve called a “base valve”. This base valve is, for example, rigidly connected to at least one pressurized fluid bottle 13. In this case, the flap-pusher 6, the movement of which is commanded by the lever 7, can command the opening or closing of an isolation flap of the base valve on which said valve 1 is connected in a removable manner.

Likewise, the pivoting lever 7 can be replaced by any other appropriate actuating member (button or wheel, that can be translated and/or rotated), etc.

The valve 1 further comprises at least one electronic functional member 10. The electronic functional member(s) 10 can comprise at least one of the following: a device for receiving and/or transmitting data wirelessly comprising an antenna, a pressure sensor, a temperature sensor, an electronic logic for storing and processing data comprising a microprocessor, a digital screen, a light source, etc.

This electronic functional member 10 is arranged in a closed casing 8 located on the body 2.

This casing 8 particularly comprises a peripheral wall in communication with the exterior of the valve 1.

According to an advantageous characteristic feature, this peripheral wall 18 comprises at least one vent hole 9 shut by a cover preferably formed from an impervious plastic material layer 11 stuck on said peripheral wall 18.

In this manner, in the case of build-up of pressurised gas in the casing 8, if the pressure in the casing 8 becomes too great, the gas will deform the stuck plastic material layer 11 by passing through the hole until it makes a passage such as to evacuate towards the exterior of the valve 1. This makes it possible to prevent greater damage to the casing 18 and to the electronic components that it contains. This makes it possible to protect the users by particularly preventing a more dangerous explosion.

The plastic material layer 11 is preferably flexible. In this way, a deformation thereof under the effect of the gas pressure can occur. This means that the stuck material layer 11 can swell before splitting.

For example, this plastic material layer 11 can comprise at least one of the following: rubber, a polymer.

In an alternative, this cover could be rigid and/or formed from a material other than plastic (for example a plate made of metal, etc).

As illustrated in FIG. 4, the plastic material layer 11 can be locally thinned at the vent hole 9, for example in line with and/or proximate to the hole 9.

Alternatively or in combination, the plastic material layer 11 can be locally or partially pre-cut to facilitate the rupture thereof in a controlled manner.

The wall 18 can include one or more vent holes 9 (for example two) having dimensions, for example, between 0.1 cm² and 0.7 cm².

Preferably, the hole/holes 9 is/are located on the peripheral wall 18 which forms an upper wall of the casing 8 and of the valve 1 when the valve 1 is configured for use.

Moreover, as shown in the diagram of FIG. 2, the casing 8 can be removably mounted on the body 2 of the valve 1.

As illustrated in FIG. 2, the casing 8 containing at least one electronic member 10 can house at least part of the fluid circuit 3 of the valve 1. For example, the casing 8 can include a circuit portion comprising at least one regulation member (flow rate and/or pressure regulator, gate, etc.). Moreover, the at least one electronic member 10 can include one or more electronic sensors (for pressure and/or for temperature, for example).

When the casing 8 is removable and comprises a portion of the fluid circuit 3, this portion can include two ends that are connected in an impervious manner (connectors) to two opposite circuit ends on the body 2 of the valve 1. In this manner, the fluid circuit 3 only makes one passage in the casing 8 (the downstream end 5 of the circuit being located on the body 2 of the valve outside the casing 8).

Alternatively, the circuit 3 portion of the casing 8 can comprise a (single) inlet and an outlet 5 forming the downstream end of the circuit 3.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A valve for pressurized fluid, comprising a body housing a fluid circuit having an upstream end configured to be connected to a pressurized fluid reserve and a downstream end configured to be connected to a receiving apparatus, the fluid circuit comprising a member for controlling the flow rate in the fluid circuit, the member for controlling the flow rate being commanded by an actuating member mobile with respect to the body housing, the valve comprising at least one electronic functional member arranged in a closed casing located on the body housing, wherein the casing comprises a peripheral wall in communication with the exterior of the valve, said peripheral wall comprising at least one vent hole shut by a cover fixed on said peripheral wall.

2. The valve of claim 1, wherein the cover comprises an impervious plastic material layer stuck on said peripheral wall.

3. The valve of claim 2, wherein the plastic material layer is flexible.

4. The valve of claim 2, wherein the plastic material layer comprises at least one of the following: rubber, a polymer.

5. The valve of claim 1, wherein the cover is locally thinned or partially pre-cut at or adjacent to the vent hole.

6. The valve of claim 1, further comprising at least two vent holes.

7. The valve of claim 1, wherein the peripheral wall comprising the at least one vent hole forms an upper wall of the casing and of the valve when the valve is configured for use.

8. The valve of claim 1, wherein the casing is removably mounted on the body housing.

9. The valve of claim 1, wherein the casing houses at least part of the casing fluid circuit.

10. The valve of claim 1, wherein the control member comprises a least one of the following: an isolation flap, a flow rate or pressure regulation gate, a mobile flap-pusher member for actuating a flap of another apparatus to which the valve is configured to be connected.

11. The valve of claim 1, wherein the at least one electronic functional member comprises at least one of the following: a device for receiving and/or transmitting data wirelessly comprising an antenna, a pressure and/or temperature sensor, an electronic logic for storing and processing data comprising a microprocessor, a digital screen, and a light source.

12. A pressurized fluid bottle or set of bottles comprising a valve of claim 1.
